(19) United States
(12) Patent Application Publication
(10) Pub. No.: US 2004/0143770 A1
(43) Pub. Date: Jul. 22, 2004

(54) Method and apparatus of resetting peripheral device

(75) Inventor: Woo-seong Yang, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-city (KR)

(21) Appl. No.: 10/755,280

(22) Filed: Jan. 13, 2004

(30) Foreign Application Priority Data
Jan. 14, 2003 (KR) 2003-2368

(51) Int. Cl. G06F 1/26

(52) U.S. Cl. 713/300

(57) ABSTRACT

A method, an apparatus, and a machine-readable medium for resetting a peripheral device. The method comprises determining whether a cutoff of a supply of power is required from the computer to the peripheral device; if it is determined that the cutoff of the supply of power is required, generating a cutoff-instructing signal for instructing the cutoff of the supply of power to the peripheral device; cutting off the power supplied to the peripheral device for a predetermined amount of time and repeatedly supplying the power to the peripheral device after the predetermined amount of time in response to the cutoff-instructing signal; and resetting the peripheral device in response to the repeatedly supplied power.

### CROSS-REFERENCE TO RELATED APPLICATIONS

This application claims the benefit of Korean Patent Application No. 2003-2368, which was filed on Jan. 14, 2003, in the Korean Intellectual Property Office, the disclosure of which is incorporated herein in its entirety by reference.

### BACKGROUND OF THE INVENTION

1. Field of the Invention

The present invention relates to a method of resetting a peripheral device that is connected to a computer and that receives its power from a power supply unit, and, more particularly, to a method and an apparatus for resetting a peripheral device which can reset the peripheral device from a distant location by temporarily cutting off the power of the peripheral device in the computer.

2. Description of the Related Art

Peripheral devices connected to a computer include various types of electronic devices such as printers, scanners, or multifunctional devices. Such peripheral devices perform their own functions while exchanging data with a computer.

A printer is an output device for printing information processed in the computer and has a function of printing information encoded and processed in the computer in a form that is readable by a person. A scanner is a device for scanning an image from a document by projecting light output from a light source onto the document, reflecting the light, converting the reflected light into an electrical output value via an image scanning sensor such as a charge-coupled device (CCD) or a contact image sensor (CIS), and storing the electrical output value in a data storage unit such as a hard disc mounted on the computer. The scanner may correct an image by reading a stored image via the computer. A multifunctional device simultaneously includes the above-described printer and scanner. Recently, the various uses of such multifunctional devices have been increasing.

Because the above peripheral devices manage various types of data, errors frequently occur therein. When the errors occur therein, a process of resetting a peripheral device is required. In order to reset the peripheral device, a user temporarily cuts off the power supplied to the peripheral device.

However, the user cuts off the power supplied to the peripheral device temporarily by turning on/off a power supply switch of the peripheral device or by removing and then replacing a power plug into a wall outlet. Thus, due to the errors occurring in the peripheral device, the user must always approach the peripheral device and physically perform the above-described operation in order to reset the peripheral devices. In particular, when a peripheral device is connected to the computer via a network, the user may be required to travel a long distance to where the peripheral device is located in order to turn off/on the power of the peripheral device.

### SUMMARY OF THE INVENTION

Accordingly, it is an aspect of the present invention to provide a method of resetting a peripheral device by temporarily cutting off the power supplied to the peripheral device even though a user does not approach the peripheral device.

It is another aspect of the present invention to provide an apparatus for resetting a peripheral device by temporarily cutting off the power supplied to the peripheral device even though the user does not approach the peripheral device.

Additional aspects and/or advantages of the present invention will be set forth in part in the description that follows, and, in part, will be obvious from the description, or may be learned by practicing the present invention.

The foregoing and/or other aspects of the present invention are achieved by providing a method of resetting a peripheral device that is connected to a computer and receives power from a power supply unit, and includes determining whether a cutoff of a supply of power is required from the computer to the peripheral device; if it is determined that the cutoff of the supply of power is required, generating a cutoff-instructing signal for instructing the cutoff of the supply of power to the peripheral device; cutting off the power supplied to the peripheral device for a predetermined amount of time and repeatedly supplying the power to the peripheral device after the predetermined amount of time in response to the cutoff-instructing signal; and resetting the peripheral device in response to the repeatedly supplied power.

The foregoing and/or other aspects of the present invention may also be achieved by providing an apparatus for resetting a peripheral device that is connected to a computer and receives power from a power supply unit, and includes a cutoff-requiring signal sensing unit, which senses whether a signal requiring a cutoff of supply of the power to the peripheral device is input from the computer and outputs a sensing result as a sensing signal; a cutoff-instructing signal generating unit, which generates a cutoff-instructing signal for instructing the cutoff of the supply of power supplied by the power supply unit and outputs the cutoff-instructing signal in response to the sensing signal; a power supply temporary cutoff unit, which cuts off the power supplied to the peripheral device for a predetermined amount of time and repeatedly supplies the power to the peripheral device after the predetermined amount of time in response to the cutoff-instructing signal; and a peripheral device resetting unit, which resets the peripheral device in response to the repeatedly supplied power.

### BRIEF DESCRIPTION OF THE DRAWINGS

These and/or other aspects and/or advantages of the present invention will become more apparent and more readily appreciated from the following description of the embodiments thereof with reference to the attached drawings in which:

FIG. 1 is a flowchart illustrating a method of resetting a peripheral device, according to an embodiment of the present invention; and

FIG. 2 is a block diagram illustrating an apparatus for resetting a peripheral device, according to an embodiment of the present invention.

### DETAILED DESCRIPTION OF THE INVENTION

Hereinafter, a method of resetting a peripheral device according to an embodiment of the present invention will be described below with reference to the accompanying drawings.

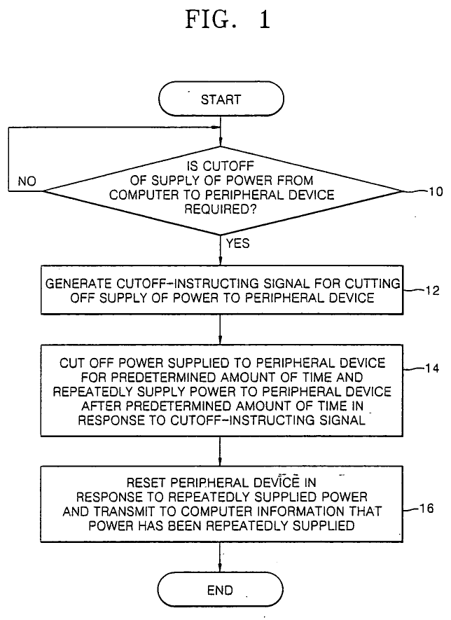

FIG. 1 is a flowchart illustrating a method of resetting a peripheral device according to an embodiment of the present invention. The method comprises determining whether a cutoff of a supply of power to the peripheral device is required, cutting-off the power to the peripheral device temporarily, and resetting the peripheral device (operations 10 through 16).

First, in operation 10, the determination of whether a cutoff of the supply of power to the peripheral device is required from a computer is performed. That is, it is determined whether a user requires a cutoff of the supply of power via the computer. Here, the power whose supply cutoff is required includes power for driving a motor of the peripheral device and logic power for operating a main board of the peripheral device. If it is determined that a cutoff of the supply of power to the peripheral device is not required, the determination of whether a cutoff of the supply of power to the peripheral device is required is continuously performed.

However, if it is determined that a cutoff of the supply of power to the peripheral device is required, in operation 12, a cutoff-instructing signal for cutting off the supply of power to the peripheral device is generated.

After operation 12, in operation 14, power supplied to the peripheral device is cut off for a predetermined amount of time, and the power is repeatedly supplied to the peripheral device after the predetermined amount of time in response to the cutoff-instructing signal. The predetermined amount of time is a time in which power is temporarily cut off so as to reset the peripheral device. In an embodiment, the predetermined amount of time is about 1-5 seconds. However, embodiments of the present invention are not so limited, as any predetermined amount of time may be used. Accordingly, the user may arbitrarily select a predetermined amount of time.

After operation 14, in operation 16, the peripheral device is reset in response to the repeatedly supplied power, and information that the repeated supply of power to the peripheral device is transmitted to the computer. If the power has been repeatedly supplied to the peripheral device, the peripheral device performs a process of returning to a reset state before errors occur in the peripheral device. Meanwhile, the information that the power has been repeatedly supplied to the peripheral device is transmitted to the computer such that the user can operate the peripheral device again using the computer.

Hereinafter, an apparatus for resetting a peripheral device according to an embodiment of the present invention will be described below with reference to the accompanying drawings.

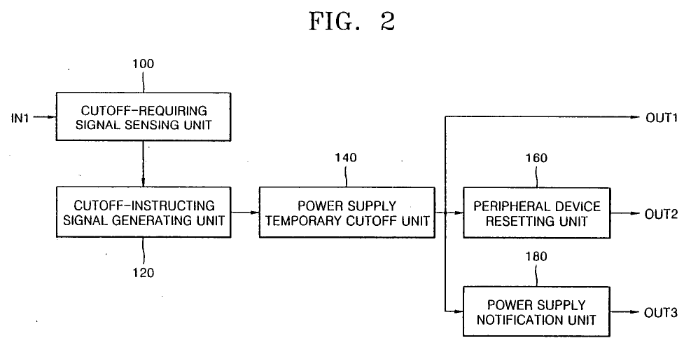

FIG. 2 is a block diagram illustrating an apparatus for resetting a peripheral device according to an embodiment of the present invention. The apparatus includes a cutoff-requiring signal sensing unit 100, a cutoff-instructing signal generating unit 120, a power supply temporary cutoff unit 140, a peripheral device resetting unit 160, and a power supply notification unit 180.

In order to perform operation 10, the cutoff-requiring signal sensing unit 100 senses whether a signal requiring a cutoff of the supply of power is input from the computer, and outputs a sensing result as a sensing signal to the cutoff-instructing signal generating unit 120. Specifically, the user inputs the signal requiring a cutoff of the supply of power via the computer. The cutoff-requiring signal sensing unit 100 senses whether the signal requiring a cutoff of the supply of power is input through an input terminal IN1, and outputs a sensing result as a sensing signal to the cutoff-instructing signal generating unit 120. The signal requiring a cutoff of the supply of power is a command for temporarily cutting off the power transmitted from the computer to the peripheral device. The signal requiring a cutoff of the supply of power has a predetermined data format previously designated between the computer and the peripheral device such that the cutoff-requiring signal sensing unit 100 interprets a variety of signals transmitted from the computer and senses the signal requiring a cutoff of the supply of power. For example, the signal requiring a cutoff of the supply of power has the following command format, so as to be distinguished from common peripheral data that is exchanged between the computer and the peripheral device:

| | | | | | | | | |
|---|---|---|---|---|---|---|---|---|
| 0000: 0x1b 0x25 0x2d 0x31 0x32 0x33 0x34 0x35 | <Esc> | % | — | 1 | 2 | 3 | 4 | 5 |
| 0008: 0x58 0x40 0x50 0x4a 0x4c 0x20 0x53 0x45 | X | @ | P | J | L | | S | E |
| 0010: 0x54 0x20 0x50 0x52 0x49 0x4e 0x54 0x45 | T | | P | R | I | N | T | E |
| 0018: 0x52 0x52 0x45 0x53 0x45 0x54 0x0a | R | R | E | S | E | T | <LF> | |

If the signal requiring a cutoff of the supply of main power having the above-described command format, which is distinguished from the common peripheral data, is input, the cutoff-requiring signal sensing unit 100 senses the signal requiring a cutoff of the supply of power from the variety of signals and outputs a sensing result as a sensing signal for cutting off the supply of power to the power supply temporary cutoff unit 140.

In order to perform operation 12, the cutoff-instructing signal generating unit 120 generates a cutoff-instructing signal for instructing a cutoff of the supply of power supplied by a power supply unit (not shown) and outputs the cutoff-instructing signal in response to the sensing signal. The power supply unit supplies power to a peripheral device, such as a printer, a scanner, or a multifunctional device, and, in an embodiment, is a switching mode power supply (SMPS) having a power switching portion (not shown), for example. The cutoff-instructing signal generating unit 120 generates the signal temporarily instructing a cutoff of the supply of power supplied by the power supply unit to the peripheral device and outputs the cutoff-instructing signal to the power supply temporary cutoff unit 140 in response to the sensing signal input from the cutoff-requiring signal sensing unit 100.

In order to perform operation 14, the power supply temporary cutoff unit 140 cuts off the power supplied to the peripheral device for a predetermined amount of time and supplies the power repeatedly after the predetermined amount of time in response to the cutoff-instructing signal. In an embodiment, the power supply temporary cutoff unit 140 is embedded in the power supply unit. The power supply temporary cutoff unit 140 embedded in the power supply unit supplies power supplied by the power supply unit to a variety of peripheral devices through an output terminal OUT1 continuously before the cutoff-instructing signal is input from the cutoff-instructing signal generating unit 120. However, if the cutoff-instructing signal is input from the cutoff-instructing signal generating unit 120 into the power supply temporary cutoff unit 140, the power supply temporary cutoff unit 140 cuts off the supply of power supplied to the variety of peripheral devices in response to the cutoff-instructing signal for a predetermined amount of time. Thereafter, the power supply temporary cutoff unit 140 repeatedly supplies the power to the variety of peripheral devices through the output terminal OUT1 after the predetermined amount of time. The predetermined amount of time is a time for temporarily cutting off power so as to reset the peripheral device. In an embodiment, the predetermined amount of time is about 1-5 seconds. However, embodiments of the present invention are not so limited, as any amount of time may be selected. Accordingly, the user may arbitrarily select a predetermined amount of time. Meanwhile, the power supply temporary cutoff unit 140 also outputs the power to the peripheral device resetting unit 160 or the power supply notification unit 180.

In order to perform operation 16, the peripheral device resetting unit 160 resets the peripheral device in response to the repeatedly supplied power. The peripheral device resetting unit 160 outputs a resetting control signal for resetting the peripheral device through an output terminal OUT2 in response to the power repeatedly supplied from the power supply temporary cutoff unit 140. The peripheral device is returned to a resetting state before errors occur in the peripheral device.

Also, in order to perform operation 16, the power supply notification unit 180 transmits to the computer information that the power has been repeatedly supplied to the peripheral device in response to the repeatedly supplied power. The power supply notification unit 180 outputs the information that the power has been repeatedly supplied to the peripheral device, through an output terminal OUT3 to the computer in response to the power repeatedly supplied from the power supply temporary cutoff unit 140. The user can know from the information transmitted by the power supply notification unit 180 that the peripheral device is operating again.

As described above, in the method and apparatus for resetting a peripheral device according to the present invention, power supplied to the peripheral device is turned on/off such that the peripheral device in which errors occur can be reset from a distant location.

The hardware included in the system may include memories, processors, and/or Application Specific Integrated Circuits (“ASICs”). Such memory may include a machine-readable medium on which is stored a set of instructions (i.e., software) embodying any one, or all, of the methodologies described herein. Software can reside, completely or at least partially, within this memory and/or within the processor and/or ASICs. For the purposes of this specification, the term “machine-readable medium” shall be taken to include any mechanism that provides (i.e., stores and/or transmits) information in a form readable by a machine (e.g., a computer). For example, a machine-readable medium includes read only memory (“ROM”), random access memory (“RAM”), magnetic disk storage media, optical storage media, flash memory devices, electrical, optical, acoustical, or other form of propagated signals (e.g., carrier waves, infrared signals, digital signals, etc.); etc.

Although a few embodiments of the present invention have been particularly shown and described, it will be understood by those skilled in the art that various changes in form and details may be made therein without departing from the spirit and scope of the present invention as defined by the appended claims and equivalents thereof.

What is claimed is:

1. A method of resetting a peripheral device that is connected to a computer and that receives power from a power supply unit, the method comprising:
determining whether a cutoff of a supply of the power is required from the computer to the peripheral device;
if it is determined that the cutoff of the supply of power is required, generating a cutoff-instructing signal for instructing the cutoff of the supply of power to the peripheral device;
cutting off the power supplied to the peripheral device for a predetermined amount of time and repeatedly supplying the power to the peripheral device after the predetermined amount of time in response to the cutoff-instructing signal; and
resetting the peripheral device in response to the repeatedly supplied power.

2. The method of claim 1, wherein the cutting off the power supplied to the peripheral device further comprises transmitting to the computer information that the power has been repeatedly supplied.

3. An apparatus for resetting a peripheral device that is connected to a computer and that receives power from a power supply unit, the apparatus comprising:
a cutoff-requiring signal sensing unit, which senses whether a signal requiring a cutoff of supply of the power to the peripheral device is input from the computer and outputs a sensing result as a sensing signal;
a cutoff-instructing signal generating unit, which generates a cutoff-instructing signal for instructing the cutoff of the supply of power supplied by the power supply unit and outputs the cutoff-instructing signal, in response to the sensing signal;
a power supply temporary cutoff unit, which cuts off the power supplied to the peripheral device for a predetermined amount of time and repeatedly supplies the power to the peripheral device after the predetermined amount of time, in response to the cutoff-instructing signal; and
a peripheral device resetting unit, which resets the peripheral device in response to the repeatedly supplied power.

4. The apparatus of claim 3, wherein the signal requiring the cutoff of the supply of power has a predetermined data format previously designated between the computer and the peripheral device such that the cutoff-requiring signal sensing unit interprets a variety of signals transmitted from the computer and senses the signal requiring the cutoff of the supply of power.

5. The apparatus of claim 3, further comprising a power supply notification unit, which transmits to the computer information that the power has been repeatedly supplied, in response to the repeatedly supplied power from the power supply temporary cutoff unit.

6. The apparatus of claim 3, wherein the power supply unit is a switching mode power supply (SMPS) that comprises a power switching portion.

7. The apparatus of claim 3, wherein the signal requiring a cutoff of supply of power has a command format that is different from common peripheral data that is exchanged between the computer and the peripheral device.

8. The apparatus of claim 3, wherein the power supply temporary cutoff unit continuously supplies the power to a variety of peripheral devices through an output terminal before the cutoff-instructing signal is input from the cutoff-instructing signal generating unit.

9. The method of claim 1, wherein the predetermined amount of time is arbitrarily selected.

10. The apparatus of claim 3, wherein the predetermined amount of time is arbitrarily selected.

11. A machine-readable medium that provides instructions for resetting a peripheral device that is connected to a computer and that receives power from a power supply unit, which, when executed by a machine, cause the machine to perform operations comprising:
determining whether a cutoff of a supply of the power is required from the computer to the peripheral device;
if it is determined that the cutoff of the supply of power is required, generating a cutoff-instructing signal for instructing the cutoff of the supply of power to the peripheral device;
cutting off the power supplied to the peripheral device for a predetermined amount of time and repeatedly supplying the power to the peripheral device after the predetermined amount of time in response to the cutoff-instructing signal; and
resetting the peripheral device in response to the repeatedly supplied power.

12. The machine-readable medium of claim 11, wherein the cutting off the power supplied to the peripheral device further comprises transmitting to the computer information that the power has been repeatedly supplied.
